(19) United States
(12) Patent Application Publication
(10) Pub. No.: US 2010/0082946 A1
(43) Pub. Date: Apr. 1, 2010

(54) Microcomputer and its instruction execution method

(75) Inventor: Seiji Fuchigami, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/318,210

(22) Filed: Dec. 23, 2008

(30) Foreign Application Priority Data
Sep. 29, 2008 (JP) 2008-250485

(51) Int. Cl. G06F 9/312; G06F 9/30

(52) U.S. Cl. 712/205; 712/208; 712/E09.033; 712/E09.028

(57) ABSTRACT

A microcomputer in accordance with an exemplary embodiment of the preset invention include an instruction decoder 14 that decodes a branch multiple instruction including a conditional branch instruction to be executed at a first execution stage and a first operation instruction to be executed at a second execution stage, and a sequential operation instruction including a second operation instruction to be executed at the second execution stage, operation information storage circuits 15 and 16 that store first operation information corresponding to the first operation instruction, a branch condition decision circuit 18 that determines the satisfaction/non-satisfaction of a branch condition based on the conditional branch instruction and outputs a decision result signal J1, a selector 17 that outputs the first operation information stored in the operation information storage circuits 15 and 16 if the decision result signal J1 indicates one of the satisfaction and non-satisfaction states of the branch condition, and a computing unit 21 that carries out an operation based on operation information output by the selector 17.

### BACKGROUND

1. Field of the Invention

The present invention relates to a microcomputer and its instruction execution method, in particular a microcomputer that executes operations through pipeline processing and its instruction execution method.

2. Description of Related Art

In microcomputers, an information processing method called “pipeline processing” has been adopted in order to improve the operation speed. In pipeline processing, operation instructions are successively put in a plurality of series of operations, and operation processing are carried out such that no blank is generated in the instruction execution periods in the computing unit. Therefore, operation instructions are speculatively fetched by predicting the subsequent operation instructions in the pipeline processing. However, among the processes carried out in the computing unit, there are processes in which the next instruction to be executed is not determined until the processing of the current instruction is completed as in the case of a conditional branch instruction or the like. When such a conditional branch instruction occurs, an instruction fetch for the subsequent operation is carried out by predicting the branch destination. However, when the prediction turns out to be incorrect, the operation instruction that is speculatively fetched must be abandoned. When such abandonment of an operation instruction occurs, a blank is generated in the execution period and the operation performance is deteriorated (hereinafter, such a blank period is called “branch penalty”).

Accordingly, Japanese Unexamined Patent Application Publication No. 6-161749 discloses an instruction method for a pipeline computer to reduce branch penalties that occur when a conditional branch instruction occurs. Japanese Unexamined Patent Application Publication No. 6-161749 discloses a technique in which when there are a non-operation instruction NOP, an operation instruction, and a branch destination instruction after a branch instruction, those branch instruction, non-operation instruction, and operation instruction are replaced with a conditional operation instruction having a condition that its branch condition is not satisfied. FIGS. 8A and 8B are an example of the simplest cases. FIG. 8A is an instruction group that constitutes the base of instructions to be adopted in a pipeline computer. Furthermore, FIG. 8B is an instruction group to be adopted in the pipeline computer.

As shown in FIG. 8A, a comparison instruction “cmp” is executed as an instruction 1. Then, a branch instruction “jg” is executed as a second instruction 2. At this branch instruction, if the r1 is greater than zero at the comparison instruction “cmp”, the process jumps to the fetch address at L1. Furthermore, if the branch condition is not satisfied, a non-operation instruction “nop” for which no operation is carried out is executed as the instruction 3. Then, an addition instruction “add” is executed as an instruction 4. On the other hand, if the branch instruction is satisfied at the conditional branch instruction “jg”, a subtraction instruction “sub” is executed as an instruction 1a.

In the case where such an instruction group is executed in a pipeline computer, when there are a non-operation instruction, an operation instruction, and a branch destination operation instruction after a branch instruction, a conditional operation instruction having a condition that the operation instruction is executed if the branch condition is not satisfied is executed as substitute for those branch instruction, non-operation instruction, and operation instruction. FIG. 8B shows such an instruction group.

As shown in FIG. 8B, the operation instruction group to be adopted in a pipeline computer includes a conditional operation instruction “add.le” that indicates the operation of the instruction 4 shown in FIG. 8A if the branch condition is not satisfied as the instruction 2. By adopting this operation instruction “add.le”, when the branch condition is satisfied, the conditional operation instruction “add.le” is not executed and the branch destination operation instruction located immediately after that conditional operation instruction, i.e., the subtraction instruction “sub” is executed. On the other hand, when the branch condition is not satisfied, the conditional operation instruction “add.le” is executed, and after that, the branch destination operation instruction, i.e., the subtraction instruction “sub” is executed.

By providing such a conditional operation instruction, the pipeline computer can reduce the number of cycles of branch penalties that occur when a branch instruction is not satisfied. For example, although it is necessary to execute the non-operation instruction “nop” if the branch instruction is not satisfied in the example shown in FIG. 8A, there is no need to execute that non-operation instruction “nop” in the pipeline computer.

FIGS. 8A and 8B shows one of the simplest examples in which the only instruction that depends on the satisfaction/non-satisfaction of a branch condition is the addition instruction “add”. The subtraction instruction “sub” is always executed regardless of the satisfaction/non-satisfaction of the condition. In such a simple case where the number of instructions that depend on the satisfaction/non-satisfaction of a branch condition is only one, it is possible to reduce the number of cycles of penalties by adopting an instruction group like the one shown in FIG. 8B.

Furthermore, FIGS. 9A and 9B shows another example disclosed in Japanese Unexamined Patent Application Publication No. 6-161749. FIG. 9B is an instruction group created from the instruction group in FIG. 9A by a technique disclosed in Japanese Unexamined Patent Application Publication No. 6-161749. Therefore, the fundamental idea for the relation between FIG. 9A and FIG. 9B are similar to that of FIGS. 8A and 8B, and therefore its detailed explanation is omitted. The example shown in FIGS. 9A and 9B are different from that of FIGS. 8A and 8B in that there is more than one instruction that is depends on the satisfaction/non-satisfaction of a branch condition. Specifically, a conditional addition instruction “add.g” of the instruction 3 and a subtraction instruction “sub” of the instruction 4 are executed if the condition of a branch instruction “jle” of the instruction 2 is not satisfied. Furthermore, a subtraction instruction “sub” of the instruction 1a and an addition instruction “add” of the instruction 2a are executed if the condition of the branch instruction “jle” of the instruction 2 is satisfied. In FIG. 9B, it is possible to reduce the number of the cycles by the number corresponding to the non-operation instruction “nop” if the condition is not satisfied in comparison with FIG. 9A.

### SUMMARY

However, the present inventor has found that the following problem. The technique described in Japanese Unexamined Patent Application Publication No. 6-161749 may not reduce the number of cycles sufficiently in certain cases where there are an instruction that is executed if a condition is satisfied and an instruction that is executed if the condition is not satisfied. One of such cases is explained hereinafter with reference to FIG. 9B.

Firstly, a case where the instruction group shown in FIG. 9B is processed in a typical pipeline having a stage for each of fetch/decoding/execution is explained. The fetch/decoding/execution are carried out for each of an comparison instruction “cmp” of the instruction 1, a branch instruction “jle” of the instruction 2, and a conditional addition instruction “add.g” of the instruction 3, and a subtraction instruction “sub” of the instruction 4 in the listed order. Meanwhile, at the execution stage of the branch instruction “jle” of the instruction 2, the decoding of the conditional addition instruction “add.g” of the instruction 3 and the fetch of the subtraction instruction “sub” of the instruction 4 are carried out. If the condition turns out to be not satisfied at the execution stage of the branch instruction “jle” of the instruction 2 in this pipeline processing, the execution for each of the addition instruction “add.g”, which is in the decoding stage, and the subtraction instruction “sub”, which is in the fetching stage, is continued without any change. In this case, the number of the cycles is reduced by the number corresponding to the non-operation instruction “nop” shown in FIG. 9A. However, if the condition turns out to be satisfied at the execution stage of the branch instruction “jle” of the instruction 2, the addition instruction “add.g”, which is in the decoding stage, and the subtraction instruction “sub”, which is in the fetching stage, must be abandoned, and the fetch process of the subtraction instruction “sub” of the instruction 1a must be newly started. That is, a two-cycle branch penalty corresponding to the decoding of the addition instruction “add.g” of the instruction 3 and the fetch process of subtraction instruction “sub” of the instruction 4 occurs.

A first exemplary aspect of an embodiment of the present invention is a microcomputer that executes an operation in pipeline processing, including: an instruction decoder that decodes a branch multiple instruction including a conditional branch instruction to be executed at a first execution stage and a first operation instruction to be executed at a second execution stage, and a sequential operation instruction including a second operation instruction to be executed at the second execution stage in the order in which the instructions are fetched, and outputs operation information in accordance with the decoded instructions; an operation information storage circuit that stores first operation information corresponding to the first operation instruction among the operation information obtained by the decoding of the branch multiple instruction; a branch condition decision circuit that determines the satisfaction/non-satisfaction of a branch condition based on conditional branch operation information corresponding to the conditional branch instruction among the operation information obtained by the decoding of the branch multiple instruction, and outputs a decision result signal; a selector that outputs the first operation information stored in the operation information storage circuit if the decision result signal indicates one of the satisfaction and non-satisfaction states of the branch condition, and outputs the second operation information corresponding to the second operation instruction if the decision result signal indicates the other of the satisfaction and non-satisfaction states of the branch condition; and a computing unit that carries out an operation based on the operation information output by the selector, and outputs an operation result signal.

Furthermore, another exemplary aspect of an embodiment of the present invention is an instruction execution method in a microcomputer that executes an operation in pipeline processing, including: decoding a branch multiple instruction including a conditional branch instruction to be executed at a first execution stage and a first operation instruction to be executed at a second execution stage to generate conditional branch operation information in accordance with the conditional branch instruction and first operation information in accordance with the first operation instruction; storing the first operation information in an operation information storage circuit; determining the satisfaction/non-satisfaction of a branch condition based on the conditional branch operation information, and decoding a sequential operation instruction including a second operation instruction to be executed at the second execution stage to generate second operation information in accordance with the second operation instruction; and carrying out an operation based on the first operation information stored in the operation information storage circuit if the branch condition turns out to be one of the satisfaction and non-satisfaction states, and carrying out an operation based on the second operation information if the branch condition turns out to be the other of the satisfaction and non-satisfaction states.

In accordance a microcomputer and its instruction execution method in accordance with one aspect of the present invention, both the first operation instruction that is executed if a branch condition is satisfied and the second operation instruction that is executed if the branch condition is not satisfied are in the decoded states at the point when the satisfaction/non-satisfaction of the branch condition becomes clear by the execution of the conditional branch instruction. Furthermore, in a microcomputer and its instruction execution method in accordance with one aspect of the present invention, either one of the first operation instruction and the second operation instruction is selectively executed in accordance with the satisfaction/non-satisfaction of the branch condition. In this way, a microcomputer and its instruction execution method in accordance with one aspect of the present invention do not generate a branch penalty regardless of the satisfaction/non-satisfaction of the branch condition.

A microcomputer and its instruction execution method in accordance with one aspect of the present invention can reduces the number of branch penalties when there is an instruction that is executed if a condition is satisfied or an instruction that is executed if the condition is not satisfied.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram of a microcomputer in accordance with an exemplary embodiment of the present invention;

FIG. 2A is a figure for illustrating an instruction group adopted in a microcomputer in accordance with an exemplary embodiment of the present invention;

FIG. 2B is a figure for illustrating an instruction group adopted in a microcomputer in accordance with an exemplary embodiment of the present invention;

FIG. 3 is a figure for illustrating an instruction group adopted in a microcomputer in accordance with an exemplary embodiment of the present invention;

FIG. 4 is a figure for illustrating an instruction group in the case where a branch condition is satisfied in a microcomputer in accordance with an exemplary embodiment of the present invention;

FIG. 5 is a figure for illustrating an instruction group in the case where a branch condition is not satisfied in a microcomputer in accordance with an exemplary embodiment of the present invention;

FIG. 6 is a flowchart illustrating operation procedure of a microcomputer in accordance with an exemplary embodiment of the present invention;

FIG. 7 is a block diagram of a modified example of a microcomputer in accordance with an exemplary embodiment of the present invention;

FIG. 8A is a figure for illustrating an instruction group adopted in a pipeline computer in the related art;

FIG. 8B is a figure for illustrating an instruction group adopted in a pipeline computer in the related art;

FIG. 9A is a figure for illustrating another example of an instruction group adopted in a pipeline computer in the related art; and

FIG. 9B is a figure for illustrating another example of an instruction group adopted in a pipeline computer in the related art.

### DETAILED DESCRIPTION OF THE EXEMPLARY EMBODIMENTS

### First Exemplary Embodiment

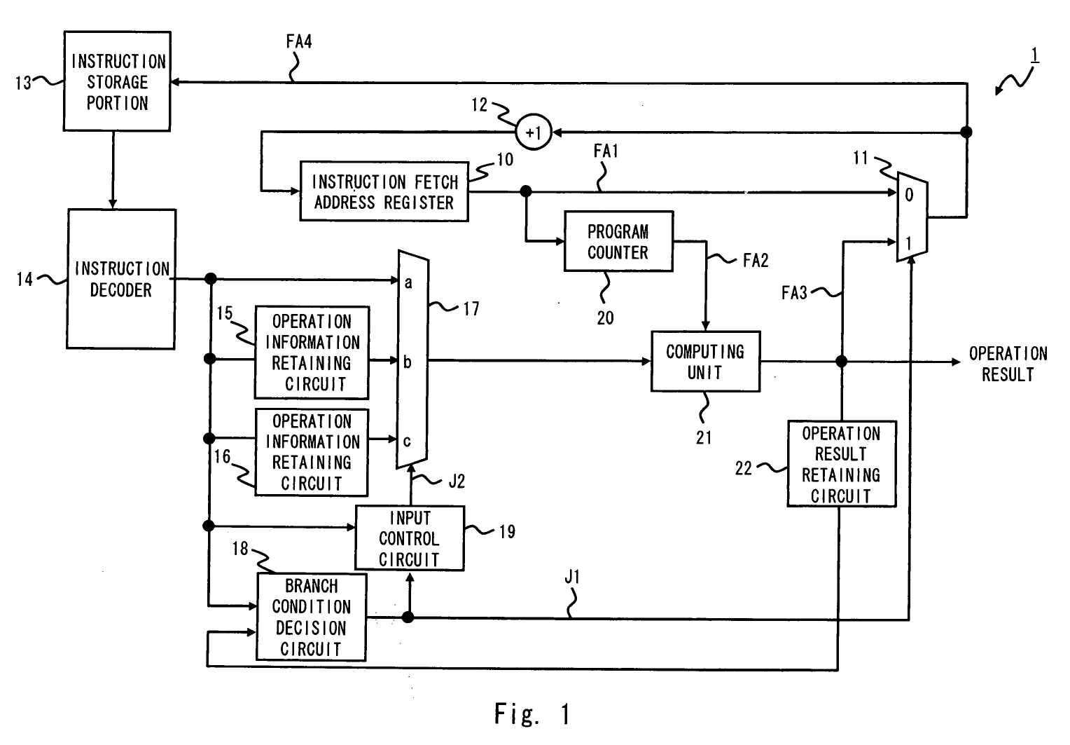

Exemplary embodiments in accordance with the present invention are explained hereinafter with reference to the drawings. FIG. 1 is a block diagram of a microcomputer in accordance with an exemplary embodiment of the present invention. Note that, in following explanation, a microcomputer 1 fetches a branch multiple instruction including a conditional branch instruction to be executed at a first execution stage and a first operation instruction to be executed at a second execution stage, and a sequential operation instruction including a second operation instruction to be executed at the second execution stage in sequence, and changes the instruction that is executed at the second execution stage depending on the satisfaction/non-satisfaction of the conditional branch instruction. Furthermore, the operation instruction that is executed at the second execution stage is not limited to a single operation instruction.

As shown in FIG. 1, a microcomputer 1 includes an instruction fetch address register 10, selectors 11 and 17, an adder 12, an instruction storage portion 13, an instruction decoder 14, instruction information retaining circuits 15 and 16, a branch condition decision circuit 18, an input control circuit 19, a program counter 20, a computing unit 21, and an operation result retaining circuit 22.

The instruction fetch address register 10 outputs a first fetch addresses FA1 in a predetermined order. The selector 11 selects either one of the first fetch address FA1 and the branch destination fetch address FA3 based on the value of a decision result signal J1, and outputs the selected address as an execution fetch address FA4. The adder 12 adds “1” to the address value of the execution fetch address FA4, and provides the resulting value to the instruction fetch address register 10. Note that the first fetch address output by the instruction fetch address register 10 is determined based on the address value supplied from the adder 12.

The instruction storage portion 13 stores a branch multiple instruction and a sequential operation instruction as being related to the value of the execution fetch address FA4. Then, the instruction storage portion 13 outputs an instruction that is related to the value of the input execution fetch address FA4 to the instruction decoder 14. The instruction decoder 14 decodes the branch multiple instruction and the sequential operation instruction in the order in which the instructions are fetched, and outputs operation information in accordance with the decoded instructions. More specifically, the instruction decoder 14 outputs conditional branch operation information corresponding to a conditional branch instruction and first operation information corresponding to a first operation instruction by decoding the branch multiple instruction. Furthermore, the instruction decoder 14 outputs second operation information corresponding to a second operation instruction by decoding the sequential operation instruction. Note that, in an exemplary embodiment of the present invention, the first operation instruction is an operation instruction that is executed if a branch condition based on the conditional branch instruction is satisfied. Furthermore, an assumption is made in an exemplary embodiment of the present invention that two pieces of operation information are contained in the first operation information. For example, the first operation information contains first-term operation information that is executed in the first half of the second execution stage and second-term operation information that is executed in the second half of the second execution stage.

The operation information retaining circuits 15 and 16 store first operation information, which is obtained by decoding the branch multiple instruction. More specifically, the instruction information retaining circuit 15 stores the first-term operation information of the first operation information, and the instruction information retaining circuit 16 stores the second-term operation information of the first operation information. Note that the number of the operation information retaining circuits can be increased or decreased depending on the number of operation information pieces contained in the first operation information.

The selector 17 has a first input terminal “a”, and second input terminals “b” and “c”. The first input terminal “a” is connected to the output of the instruction decoder 14. The second input terminal “b” is connected to the output of the instruction information retaining circuit 15 The second input terminal “c” is connected to the output of the instruction information retaining circuit 16 Furthermore, the selector 17 selects one of the operation information pieces input from the three input terminals based on a selector control signal J2, and outputs the selected operation information. Note that, in an exemplary embodiment of the present invention, the selector control signal J2 is output by the input control circuit 19 (which is explained later).

In response to input of the conditional branch operation information decoded at the instruction decoder 14, the branch condition decision circuit 18 refers to an operation result that is calculated before a process for the conditional branch operation information is carried out, and determines whether the branch condition is satisfied or not. Then, this decision result is output as a decision result signal J1 indicating the satisfaction/non-satisfaction of the conditional branch. In response to input of the conditional branch operation information decoded at the instruction decoder 14, the input control circuit 19 refers to the decision result signal J1. Then, if the decision result signal J1 indicates that the conditional branch is satisfied, it outputs a selector control signal J2. More specifically, the selector control signal J2 is a control signal to change the input terminal that is selected by the selector 17 at predefined timing. That is, by operating in response to the selector control signal J2, the selector 17 changes the input terminal to be selected at the predefined timing if the decision result signal J1 indicates the satisfaction of the branch condition.

The program counter 20 delays the first fetch address FA1 output from the instruction fetch address register 10 and outputs it as a second fetch address FA2. In an exemplary embodiment of the present invention, there is an interval corresponding to two processing stages between when a first fetch address FA1 is output and when an instruction corresponding to the first fetch address is processed at the computing unit 21. Therefore, in an exemplary embodiment of the present invention, the first fetch address FA1 is output after delayed by an amount corresponding to two processing stage as a second fetch address FA2.

The computing unit 21 executes an operation based on the operation information input through the selector 17. More specifically, if the input operation information is a conditional branch operation information, the computing unit 21 outputs a branch destination fetch address FA3 by calculating a fetch address at the branch destination based on the second fetch address. Meanwhile, if the input operation information is information corresponding to a first operation instruction or a second operation instruction, the computing unit 21 outputs the result of an operation such as addition.

The operation result retaining circuit 22 retains an operation result calculated at the computing unit 21, and outputs a retained operation result to the branch condition decision circuit 18. Note that the operation result retained in the operation result retaining circuit 22 is updated whenever an operation is carried out at the computing unit 21.

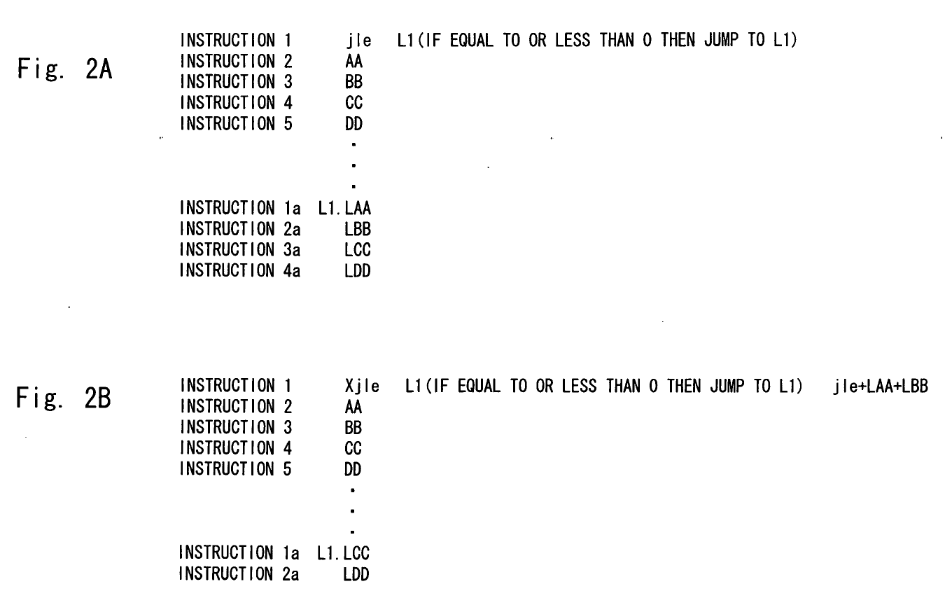

Next, the details of a branch multiple instruction and a sequential operation instruction that are adopted in an exemplary embodiment of the present invention are explained hereinafter. FIGS. 2A and 2B is a figure for illustrating an instruction group adopted in an exemplary embodiment of the present invention. FIG. 2A shows an example of a standard instruction group describing a process that is carried out in an exemplary embodiment of the present invention. FIG. 2B shows an example of an instruction group that is adopted in an exemplary embodiment of the present invention.

As shown in FIG. 2A, a conditional branch instruction “jle” is first executed based on the result of an operation that is executed before the instruction 1 in an exemplary embodiment of the present invention. At this point, if the branch condition is satisfied, the process jumps to the L1 and executes sequential operation instructions LAA-LDD related to fetch addresses at and behind the L1. On the other hand, if the branch condition is not satisfied, it executes sequential operation instructions AA-DD related to fetch addresses following the conditional branch instruction “jle”.

For such operation processing, an exemplary embodiment of the present invention uses a branch multiple instruction “Xjle”. The branch multiple instruction “Xjle” is an instruction including a conditional branch instruction “jle” that is executed at a first execution stage and sequential operation instructions LAA and LBB that are executed at a second execution stage following the first execution stage after the conditional branch is satisfied. Note that the sequential operation instruction is an instruction whose fetch address is consecutive to the fetch address of another instruction that is executed immediately after that instruction, and in which an operation to be carried out at the computing unit 21 is defined in a plain manner.

As shown in FIG. 2B, by using the branch multiple instruction “Xjle”, the sequential instructions LCC and LDD are defined at the branch destination, i.e., at the L1. Then, the microcomputer 1 in accordance with an exemplary embodiment of the present invention executes the conditional branch instruction “jle” included in the branch multiple instruction “Xjle”. Then, if the branch condition is satisfied, it jumps to the L1 and fetches the sequential operation instructions LCC and LDD. On the other hand, after executing the conditional branch instruction “jle” included in the branch multiple instruction “Xjle”, if the branch condition is not satisfied, it fetches the sequential operation instructions AA-DD.

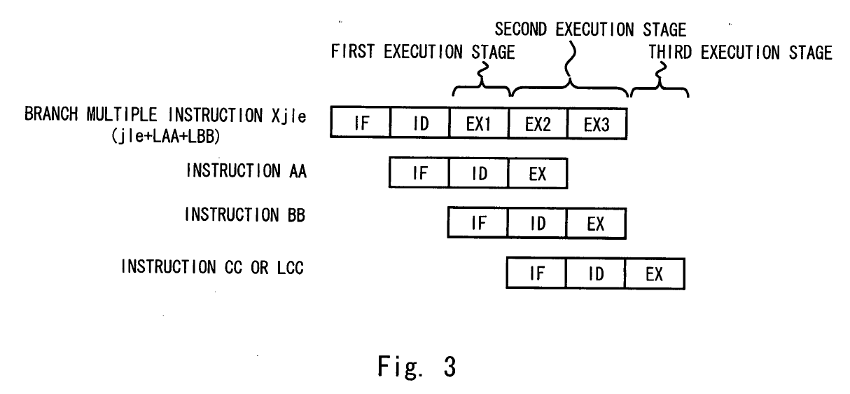

Next, FIG. 3 shows an instruction execution sequence when the instruction group shown in FIG. 2B is executed in the microcomputer 1. As shown in FIG. 3, each instruction is fetched at a fetch stage IF, decoded at a decode stage ID, and executed at an execution stage EX. Furthermore, assume that one instruction is fetched at one processing stage in the microcomputer 1.

Firstly, the branch multiple instruction “Xjle” includes a conditional branch instruction “jle” and a first operation instruction (e.g., instructions LAA and LBB) that is executed after the branch condition is satisfied. The instructions LAA and LBB are sequential operation instructions. Therefore, by passing the fetch stage IF and the decode stage ID, conditional branch operation information corresponding to the conditional branch instruction “jle” and two pieces of first operation information corresponding to the instructions LAA and LBB are generated from the branch multiple instruction “Xjle”. The conditional branch operation information is executed at a first execution stage. Then, if the branch condition is satisfied, the two pieces of first operation information are executed at a second execution stage. Furthermore, the first operation information corresponding to the instruction LAA is stored in the instruction information retaining circuit 15, and the first operation information corresponding to the instruction LBB is stored in the instruction information retaining circuit 16.

An instruction AA is fetched one processing stage later than the branch multiple instruction “Xjle”. The instruction AA is a second operation instruction, and a sequential operation instruction. By passing the fetch stage IF and the decode stage ID, the instruction AA becomes second operation information that is executed in the first half of the second execution stage if the branch condition is not satisfied. An instruction BB is fetched one processing stage later than the instruction AA. The instruction BB is a second operation instruction, and a sequential operation instruction. By passing the fetch stage IF and the decode stage ID, the instruction BB becomes second operation information that is executed in the second half of the second execution stage if the branch condition is not satisfied.

The instruction that is fetched one processing stage later than the instruction BB changes depending on whether the branch condition is satisfied or not. Specifically, if the branch condition is not satisfied, an instruction CC following the instruction BB is fetched. On the other hand, if the branch condition is satisfied, an instruction LCC following the instruction LBB is fetched. Each of the instructions CC and LCC is a sequential operation instruction. By passing the fetch stage IF and the decode stage ID, the instructions CC and LCC become operation information to be executed at a third execution stage.

By carrying out such operations, the microcomputer 1 becomes a state in which both the instruction that is executed if the branch condition is satisfied and the instruction that is executed if the branch condition is not satisfied are in the decoded states when the first execution stage at which the decision on the branch is made is completed. Then, the microcomputer 1 selects either one of the two instructions based on the branch decision.

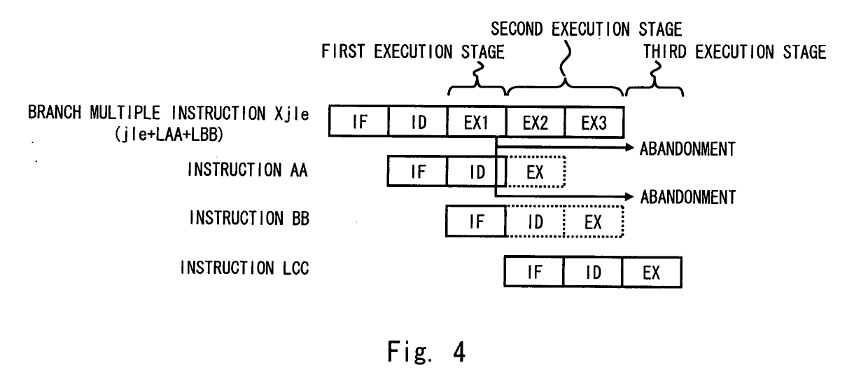

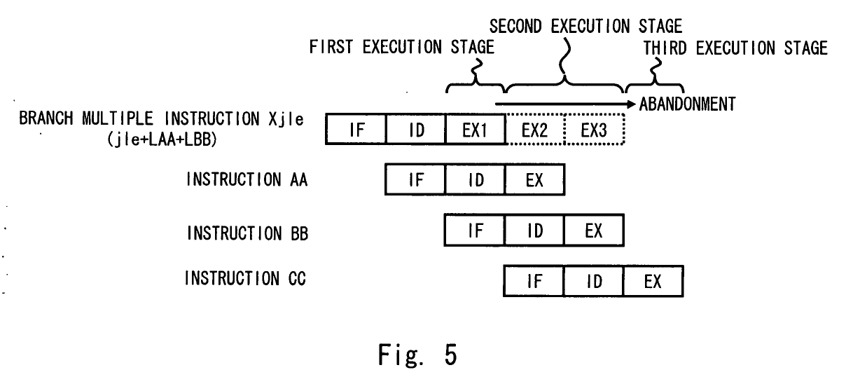

When this selecting action is carried out, the instruction that is not selected is abandoned. Accordingly, FIG. 4 shows the instruction group when the branch condition is satisfied, and FIG. 5 shows the instruction group when the branch condition is not satisfied. As shown in FIG. 4, if the branch condition is satisfied, the instructions AA and BB are abandoned. Furthermore, if the branch condition is satisfied, the instruction LCC located at the branch destination is fetched. Meanwhile, as shown in FIG. 5, if the branch condition is not satisfied, the first operation information corresponding to the instructions LAA and LBB is abandoned. Furthermore, if the branch condition is not satisfied, the instruction CC following the instruction BB is fetched.

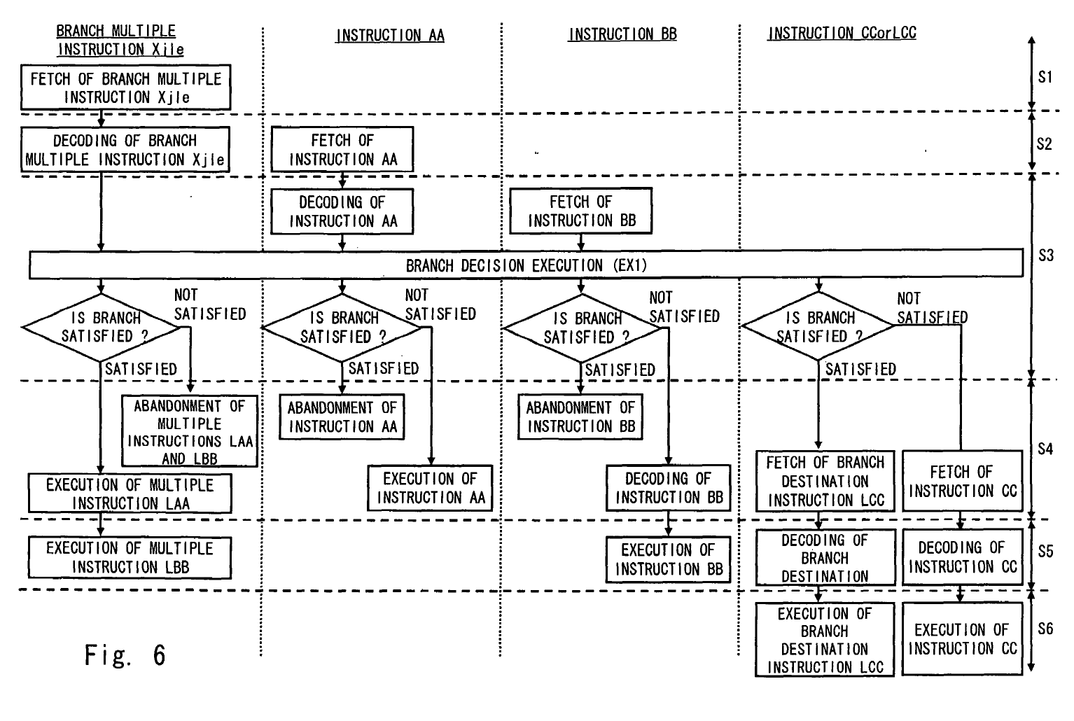

Next, FIG. 6 shows a flowchart illustrating instruction execution procedure in the microcomputer 1. Furthermore, the operation of the microcomputer 1 is explained hereinafter with reference to FIG. 6. As shown in FIG. 6, the microcomputer 1 fetches a branch multiple instruction “Xjle” at a step S1. Then, it fetches an instruction AA following the branch multiple instruction “Xjle”, while decoding the branch multiple instruction “Xjle” fetched at the step S1 at the instruction decoder 14 at the same time (step S2). In this decoding process in this step S2, conditional branch operation information from the branch multiple instruction “Xjle”, first operation information corresponding to the instruction LAA, and first operation information corresponding to the instruction LBB are obtained. Then, the first operation information corresponding to the instruction LAA is stored in the instruction information retaining circuit 15, and the first operation information corresponding to the instruction LBB is stored in the instruction information retaining circuit 16. Furthermore, the selector 17 is in a state where the first input terminal “a” is selected during these steps S1 and S2.

Then, at a step S3, it fetches an instruction BB following the instruction AA, while decoding the instruction AA fetched at the step S2 at the instruction decoder 14. Furthermore, at the step S3, the conditional branch operation information obtained in the decoding process at the step S2 is input to the branch condition decision circuit 18 and the input control circuit 19. In this way, the branch condition decision circuit 18 refers to the operation result retaining circuit 22 for an operation result that is already calculated, and executes a branch decision to determine whether the branch condition is satisfied or not (EX1). If the branch condition is satisfied in the branch decision at the step S3, the branch condition decision circuit 18 brings the decision result signal J1 to a branch condition satisfied state. Then, in response to this decision result signal J1, the input control circuit 19 outputs a selector control signal J2 that instructs the selector 17 to change the input terminal to be selected at predefined timing. On the other hand, if the branch condition is not satisfied in the branch decision at the step S3, the branch condition decision circuit 18 brings the decision result signal J1 to a branch condition non-satisfied state. Then, in response to this decision result signal J1, the input control circuit 19 outputs the selector control signal J2 that instructs the selector 17 to leave the input terminal to be selected unchanged at the first input terminal “a”.

The operations at and after a step S4 change depending on the result of the branch decision at the step S3. Accordingly, operations that are carried out if the branch condition is satisfied at the step S3 are firstly explained hereinafter. In this case, the selector 17 selects the second input terminal “b” at the step S4. Therefore, the first operation information that corresponds to the instruction LAA and is stored in the instruction information retaining circuit 15 is output from the selector 17. Then, the computing unit 21 executes the instruction LAA based on the operation information output from the selector 17. Meanwhile, since the selector 17 is selecting the second input terminal “b”, the instructions AA and BB are not sent to the computing unit 21 and virtually abandoned. Furthermore, since the branch condition is satisfied, the instruction LCC located at the branch destination is fetched at the step S4.

Then, the selector 17 selects the second input terminal “c” at a step S5. Therefore, the first operation information that corresponds to the instruction LBB and is stored in the instruction information retaining circuit 16 is output from the selector 17. Then, the computing unit 21 executes the instruction LBB based on the operation information output from the selector 17. Furthermore, the instruction decoder 14 decodes the instruction LCC fetched at the step S4. Then, the selector 17 changes the input terminal to be selected to the first input terminal “a” based on the selector control signal J2 at a step S6. Therefore, the operation information of the instruction LCC decoded by the instruction decoder 14 at the step S5 is output from the selector 17. Then, the computing unit 21 executes the instruction LCC based on the operation information output from the selector 17.

Next, operations that are carried out if the branch condition is not satisfied at the step S3 are explained hereinafter. In this case, the selector 17 selects the first input terminal “a” at the step S4. Therefore, the second operation information that corresponds to the instruction AA and is decoded by the instruction decoder 14 at the step S3 is output from the selector 17. Then, the computing unit 21 executes the instruction AA based on the operation information output from the selector 17. Furthermore, the instruction decoder 14 decodes the instruction BB fetched at the step S3. Meanwhile, since the selector 17 is selecting the first input terminal “a”, the operation information corresponding to the instructions LAA and LBB are not sent to the computing unit 21 and become virtually abandoned states. Furthermore, since the branch condition is not satisfied, an instruction CC following the instruction BB is fetched at the step S4.

Then, the selector 17 selects the input terminal “a” again at the step S5. Therefore, the second operation information that corresponds to the instruction BB and is decoded by the instruction decoder 14 at the step S4 is output from the selector 17. Then, the computing unit 21 executes the instruction BB based on the operation information output from the selector 17. Furthermore, the instruction decoder 14 decodes the instruction CC fetched at the step S4. Then, the selector 17 selects the input terminal “a” again at the step S6. Therefore, the operation information that corresponds to the instruction CC and is decoded by the instruction decoder 14 at the step S5 is output from the selector 17. Then, the computing unit 21 executes the instruction CC based on the operation information output from the selector 17.

As explained above, a microcomputer 1 in accordance with an exemplary embodiment of the present invention decodes a branch multiple instruction “Xjle” in which a conditional branch instruction “jle” and a first operation instruction that is executed subsequent to the conditional branch instruction “jle” are combined, and retains operation information generated by the decoding, except for the conditional branch operation information, in the operation information retaining circuits 15 and 16 for a subsequent process. Then, it decodes a second operation instruction that is different from the first operation instruction and is processed following the conditional branch instruction “jle”, while making a branch decision based on the branch condition operation information at the branch condition decision circuit. In this way, the microcomputer 1 becomes a state in which both the operation information that is executed if the branch condition is satisfied and the operation information that is executed if the branch condition is not satisfied are prepared at the same instant as the branch decision is made. Then, the microcomputer 1 makes a selection on which of the two operation information pieces is used based on the satisfaction/non-satisfaction of the branch condition. Therefore, the microcomputer 1 can execute the subsequent processes without causing a blank period (branch penalty) at processing stages in either case of the satisfaction/non-satisfaction of the branch condition. That is, the microcomputer 1 does not cause deterioration in the processing performance regardless whether the branch condition is satisfied or not. In other words, it is possible to reduce the number of branch penalties when there is an instruction that is executed if a condition is satisfied or an instruction that is executed if the condition is not satisfied.

Note that, although an embodiment in which the branch multiple instruction “Xjle” includes a sequential operation instruction that is executed if the branch condition is satisfied is explained in the above-described exemplary embodiment of the present invention, the branch multiple instruction may includes a sequential operation instruction that is executed if the branch condition is not satisfied depending on the structure of an microcomputer. Furthermore, the number of the sequential operation instructions included in the branch multiple instruction “Xjle” is preferably increased or decreased in accordance with the number of processing stages between the stage at which the branch multiple instruction “Xjle” is fetched and the first execution stage at which the branch decision is made. This is because, by making the number of the sequential operation instructions included in the branch multiple instruction “Xjle” consistent with the number of processing stages between the stage at which the branch multiple instruction “Xjle” is fetched and the first execution stage at which the branch decision is made, it is possible to eliminate any blank period in the processing stages.

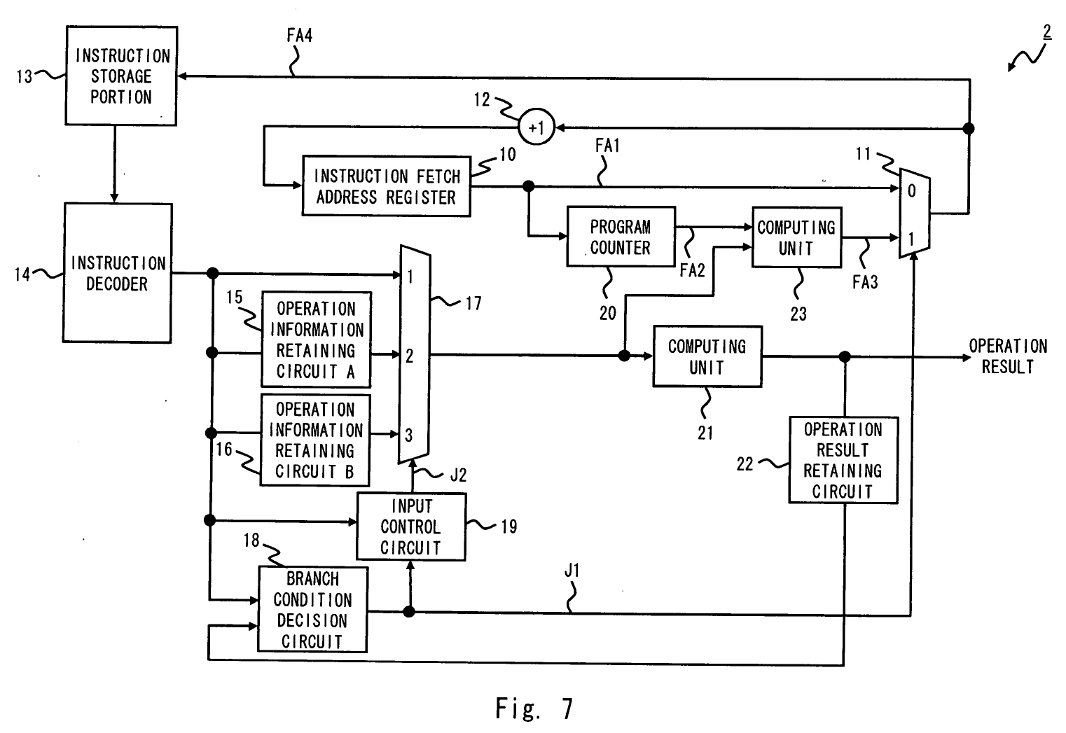

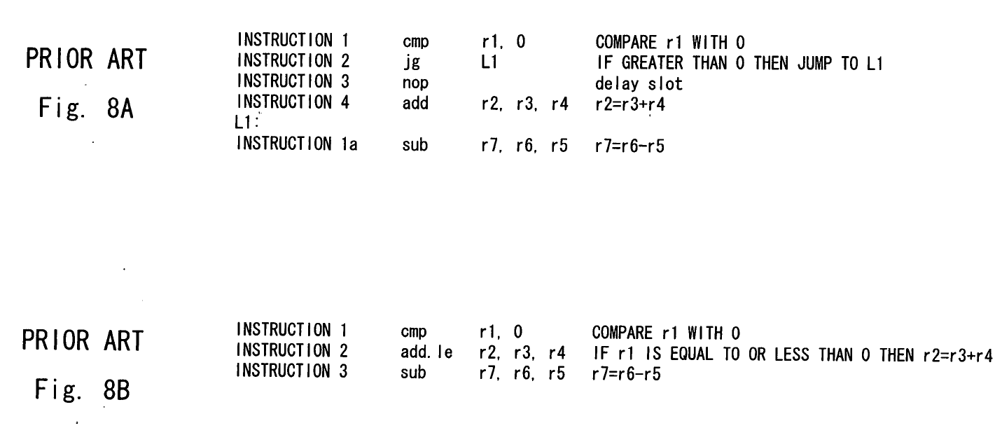

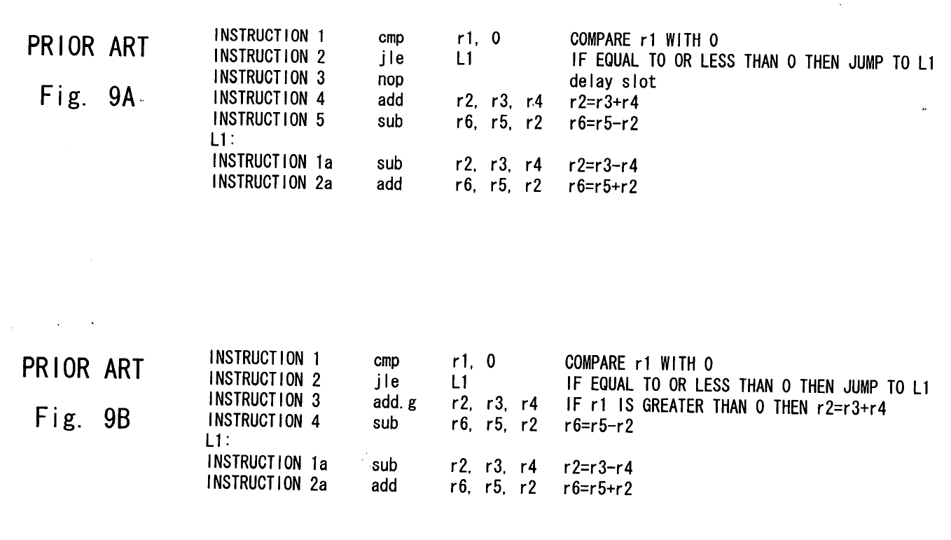

Furthermore, FIG. 7 is a block diagram of another microcomputer 2 configured as a modified example of the microcomputer 1. As shown in FIG. 7, the microcomputer 2 has an additional adder 23 to calculate the branch destination fetch address FA3. The adder 23 adds the output from the selector 17 to the second fetch address FA2 output from the program counter 20, and outputs the branch destination fetch address FA3. With such a configuration, the structure of the computing unit 21 can be simplified.

Note that the present invention is not limited to the above-described exemplary embodiments, and modifications can be made as appropriate without departing the spirit of the present invention.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A microcomputer that executes an operation in pipeline processing, comprising:
an instruction decoder that decodes a branch multiple instruction including a conditional branch instruction to be executed at a first execution stage and a first operation instruction to be executed at a second execution stage, and a sequential operation instruction including a second operation instruction to be executed at the second execution stage in the order in which the instructions are fetched, and outputs operation information in accordance with the decoded instructions;
an operation information storage circuit that stores first operation information corresponding to the first operation instruction among the operation information obtained by the decoding of the branch multiple instruction;
a branch condition decision circuit that determines the satisfaction/non-satisfaction of a branch condition based on conditional branch operation information corresponding to the conditional branch instruction among the operation information obtained by the decoding of the branch multiple instruction, and outputs a decision result signal;
a selector that outputs the first operation information stored in the operation information storage circuit if the decision result signal indicates one of the satisfaction and non-satisfaction states of the branch condition, and outputs the second operation information corresponding to the second operation instruction if the decision result signal indicates the other of the satisfaction and non-satisfaction states of the branch condition; and
a computing unit that carries out an operation based on the operation information output by the selector, and outputs an operation result signal.

2. The microcomputer according to claim 1, wherein:
the selector comprises a first input terminal to receive the output of the instruction decoder and a second input terminal to receive the output of the operation information storage circuit; and
the selector changes an input terminal to be selected from the first input terminal to the second input terminal at predefined timing if the decision result signal indicates one of the satisfaction and non-satisfaction states of the branch condition.

3. The microcomputer according to claim 2, further comprising an input control circuit that controls the predefined timing.

4. The microcomputer according to claim 1, further comprising an operation result retaining circuit that retains an operation result of the computing unit,
wherein the branch condition decision circuit determines the satisfaction/non-satisfaction of the branch condition by referring an operation result, the operation result being already calculated and retained in the operation result retaining circuit.

5. The microcomputer according to claim 1, further comprising:
an instruction fetch address register that outputs a first fetch address in a predetermined order;
a program counter that outputs a second fetch address corresponding to an instruction currently executed in the computing circuit by delaying the first fetch address;
a selector that makes a selection between the first fetch address and a branch destination fetch address based on the decision result signal and outputs the selected fetch address as the execution fetch address, the branch destination fetch address being calculated by the computing circuit based on the second fetch address; and
an instruction storage portion that stores the branch multiple instruction and the sequential operation instruction as being related to the execution fetch address and outputs an instruction rerated to the input execution fetch address.

6. The microcomputer according to claim 5, further comprising an adder that generates the branch destination fetch address by adding an operation result calculated based on the branch operation information to the second fetch address.

7. The microcomputer according to claim 1, wherein if the second execution stage includes a plurality of execution stages, the operation information storage circuit comprises the corresponding number of operation information storage circuits to the number of the execution stages.

8. The microcomputer according to claim 1, wherein the first operation instruction is an operation instruction that is executed if the branch condition turned out to be one of the satisfaction and non-satisfaction states in the conditional branch instruction; and
the second operation instruction is an operation instruction that is executed if the branch condition turned out to be the other of the satisfaction and non-satisfaction states in the conditional branch instruction.

9. An instruction execution method in a microcomputer that executes an operation in pipeline processing, the instruction execution method comprising:
decoding a branch multiple instruction including a conditional branch instruction to be executed at a first execution stage and a first operation instruction to be executed at a second execution stage to generate conditional branch operation information in accordance with the conditional branch instruction and first operation information in accordance with the first operation instruction;
storing the first operation information in an operation information storage circuit;
determining the satisfaction/non-satisfaction of a branch condition based on the conditional branch operation information, and decoding a sequential operation instruction including a second operation instruction to be executed at the second execution stage to generate second operation information in accordance with the second operation instruction; and
carrying out an operation based on the first operation information stored in the operation information storage circuit if the branch condition turns out to be one of the satisfaction and non-satisfaction states, and carrying out an operation based on the second operation information if the branch condition turns out to be the other of the satisfaction and non-satisfaction states.

10. The instruction execution method in a microcomputer according to claim 9, wherein an operation instruction at a branch destination is fetched based on the conditional branch operation information if the branch condition is determined to be satisfied, and an operation instruction is fetched without carrying out a jump of an instruction fetch address if the branch condition is determined to not be satisfied.

11. The instruction execution method in a microcomputer according to claim 9, wherein the decision whether the branch condition is satisfied or not is carried out by referring an operation result calculated before the conditional branch operation information is processed.
